(19) United States
(12) Patent Application Publication
(10) Pub. No.: US 2017/0287040 A1
(43) Pub. Date: Oct. 5, 2017

(54) METHOD AND SYSTEM FOR COMMUNICATING PRODUCT DATA CORRESPONDING TO A PRODUCT

(71) Applicant: MASTERCARD ASIA/PACIFIC PTE LTD, Singapore (SG)

(72) Inventors: Jiaming Li, Singapore (SG); Yong How Chin, Singapore (SG); Bensam Joyson, Singapore (SG); Hao Tang, Singapore (SG); Xijing Wang, Singapore (SG); Senxian Zhuo, Singapore (SG); Donghao Huang, Singapore (SG)

(21) Appl. No.: 15/463,843

(22) Filed: Mar. 20, 2017

(30) Foreign Application Priority Data
Mar. 30, 2016 (SG) 10201602498S

(51) Int. Cl. G06Q 30/06; H04W 4/08

(52) U.S. Cl. CPC G06Q 30/0623; H04W 4/08

(57) ABSTRACT

A method for communicating product data corresponding to a product is provided. The method includes receiving a data package including a visual representation of at least part of the product and signal data using a receiver module, the signal data including an identifier of the product. The method also includes extracting the signal data from the data package using a decoder module in response to a command to display the visual representation. The method further includes retrieving, using a processor module, the product data from a memory module in response to the identifier in the extracted signal data, the memory module having stored therein the identifier in association with the product data. The method also includes communicating the product data using an output module during display of the visual representation.

### CROSS REFERENCE TO RELATED APPLICATIONS

This application claims the benefit of Singapore Patent Application No. SG10201602498S filed Mar. 30, 2016, which is hereby incorporated by reference in its entirety.

The present disclosure relates broadly, but not exclusively, to systems and methods for communicating product data corresponding to a product.

### BACKGROUND

Currently, when consumers see a product that interests them, they may have to make an effort to find out more about the product, such as the price of the product and which merchant sells the product. For example, if a consumer sees someone on the street wearing a nondescript jacket and wishes to identify and find out more about the jacket, they have to search the Internet using some descriptive keywords. However, this process may not be straightforward as there is a need for the user to think up the descriptive keywords, which can be difficult for some products, e.g. a nondescript black jacket.

In scenarios where consumers are remote from the product (e.g. an image of the product is seen by the consumer on a display screen), it is difficult for the consumers to identify and find out more about the product.

There is, thus, a need to provide methods and systems for communicating product data corresponding to a product that seek to address at least some of the above problems.

### BRIEF DESCRIPTION

According to one aspect of the disclosure, a method for communicating product data corresponding to a product is provided. The method includes receiving a data package including a visual representation of at least part of the product and signal data using a receiver module, the signal data includes an identifier of the product, extracting the signal data from the data package using a decoder module in response to a command to display the visual representation, retrieving, using a processor module, the product data from a memory module in response to the identifier in the extracted signal data, the memory module having stored therein the identifier in association with the product data, and communicating the product data using an output module during display of the visual representation.

According to another aspect of the disclosure, a system for communicating product data corresponding to a product is provided. The system includes a receiver module configured to receive a data package including a visual representation of at least part of the product and signal data, the signal data including an identifier of the product, a decoder module configured to extract the signal data from the data package in response to a command to display the visual representation, a processor module configured to retrieve the product data from a memory module in response to the identifier in the extracted signal data, the memory module having stored therein the identifier in association with the product data, and an output module configured to communicate the product data during display of the visual representation.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows a schematic of a system for communicating product data corresponding to a product according to an example embodiment.

FIG. 2 shows a flow chart of a method for communicating product data corresponding to a product according to an example embodiment.

FIG. 3 shows a schematic diagram of a wireless device suitable for use in the example embodiments.

FIG. 4 shows a schematic diagram of a computer system suitable for use in the example embodiments.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may include a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

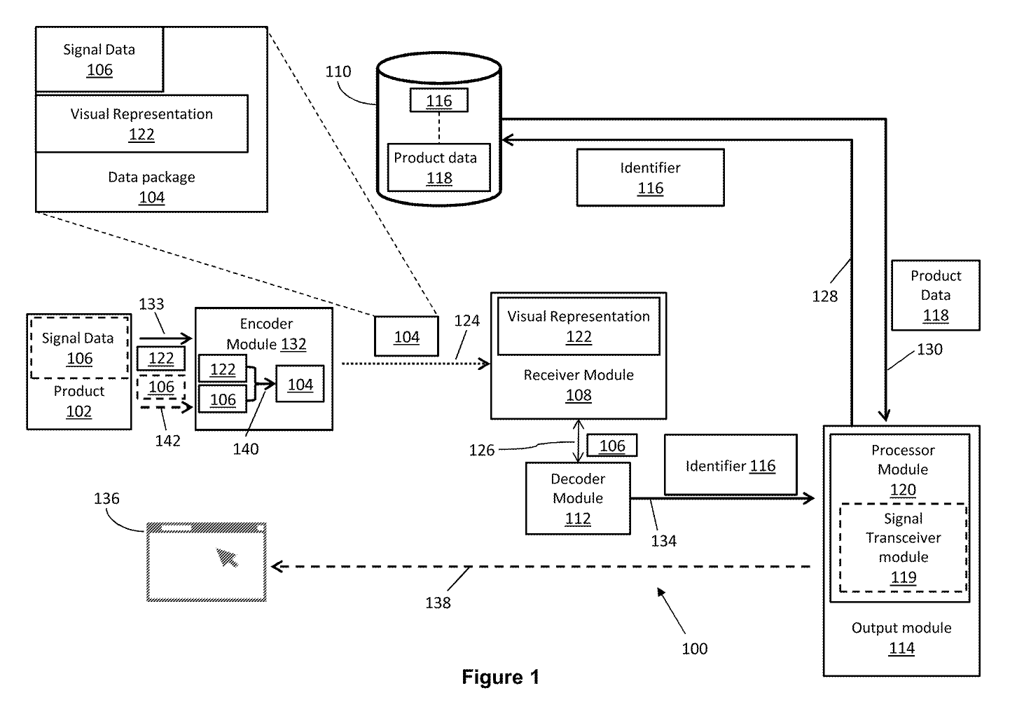

FIG. 1 shows a schematic of a system 100 for communicating product data 118 corresponding to a product 102 according to an example embodiment. In the following description, the product 102 may be a good and/or a service (e.g. a dress, a jacket, a food product such as French fries, or a vacation product such as a trip to Bali). The product data 118 corresponding to the product 102 may include, but is not limited to, a smell associated with the product 102, a sound associated with the product 102, a description associated with the product 102 (color, shape, material, model name, manufacturer, key features, etc.), a price associated with the product 102, and merchant(s) who is/are offering the product 102 for sale (name of merchant, address of merchant's store, address of merchant's web-store, etc.). The product data associated with the French fries may be a typical smell of French fries, and the product data associated with the trip to Bali may be the scent of the sea or the sound of waves.

The system 100 includes a receiver module 108. The receiver module 108 is configured to receive a data package 104 that includes a visual representation 122 of at least part of the product 102 and signal data 106. In the present embodiment, the visual representation 122 may have one or more of an image file or a video file of the product 102. For example, if the product 102 is a dress, the visual representation 122 may be a photo or a video of a model wearing the dress. The data package 104 may be provided 124 to the receiver module 108 via any suitable communication protocol from a content provider. For the sake of simplicity, the content provider is not depicted and described in the present application. Alternatively, the data package 104 may be stored in a computer readable storage media provided by the content provider. The receiver module 108 reads the computer readable storage media and receives the data package 104. In the present embodiment, the computer readable storage media that provides the data package 104 refers to any non-transitory tangible storage medium that provides recorded instructions and/or data packages to the receiver module 108 for execution and/or processing. Examples of such storage media include magnetic tape, CD-ROM, DVD, Blu-ray™ Disc, a hard disk drive, a ROM or integrated circuit, USB memory, a magneto-optical disk, or a computer readable card such as a SD card and the like. The receiver module 108 may also be configured to display the visual representation 122 of at least part of the product 102.

The system 100 also includes a memory module 110 where the product data 118 are stored therein. It could be appreciated by the skilled person in the art that there may easily be more than one set of product data that corresponds to one or more products, stored in the memory module 110. Alternatively or in addition, each product may have more than one corresponding product data. Every set of product data is assigned a unique identifier (e.g. an address in the memory module 110) for facilitating retrieval of product data.

The system 100 further includes a decoder module 112 that is in communication with the receiver module 108. As shown in FIG. 1, the signal data 106 along with the visual representation 122 included in the data package 104 is received 124 by the receiver module 108. The decoder module 112 is configured to extract 126 the signal data 106 from the data package 104 in response to a command (not shown) to display the visual representation 122. The receiver module 108 may be a digital frame that is configured to display the visual representation 122 (e.g. pictures and videos), or a TV screen, or a display screen of a personal computer, or an outdoor display screen. The command may be in the form of the receiver module 108 being switched on, or the “play” function being activated, or the like. In one embodiment, the decoder module 112 may be as a component incorporated into the receiver module 108. Alternatively, the decoder module 112 may be a stand-alone module working in cooperation with the receiver module 108.

Upon the decoder module 112 extracting 126 the signal data 106, an identifier 116 included in the signal data 106 is obtained. In an embodiment, the signal data 106 further includes data representing a signal that is used to transmit the identifier 116. The signal that is used to transmit the identifier 116 is in accordance with one or more of the following communication protocols: Bluetooth™, Bluetooth™ low energy (BLE), Wi-Fi®, Wi-Fi Direct®, and the like. For example, when the identifier 116 is to be transmitted via a BLE signal, the data related to the BLE signal that can be used to transmit the identifier 116 may be represented in the form of {“ble_service_id”: uuid, “ble_characteristic_id”: uuid, “ble_characteristic_value”: value}. The uuid stands for universal unique identifier, and is a value of the corresponding field of “ble_service_id” or “ble_characteristic_id”. The “ble_characteristic_value” may be any format supported by the BLE characteristics, like an integer or a string. In the present embodiment, the uuid and the value are pre-determined to reflect the identifier 116. The above example of data representing the signal used to transmit the identifier 116 is in JavaScript Object Notation (JSON) format. It could be appreciated to the skilled person that the data representing the signal may also be in any other similar format, such as Extensible Markup Language (XML) format, a tabular format, such as Comma Separated Values (CSV) format or the like.

In an embodiment where the visual representation 122 includes a video file, the signal data 106 may further include data representing time related information associated with the product data 118, e.g. the time to start communicating 130 the product data 118, the duration of the provision 130 of the product data 118. In this manner, the product data 118 can be communicated at an appropriate time and/or for an appropriate duration corresponding to the visual representation 122 of at least part of the product 102 being displayed. It could be appreciated to the skilled person that the video file may be in the form of motion images.

In another embodiment, the signal data 106 may further include a strength of the signal that is used to transmit the identifier 116. For example, the strength of the signal may be 55 dB. The strength of the signal may represent an effective communication distance between the decoder module 112 and a signal transceiver module 119. In such an implementation, the decoder module 112 may include a sub-module (not shown) that is configured to emit 134 a signal in accordance with the data that includes the strength of the signal.

An example signal data 106 including the above described identifier 116 and/or the other relevant data can be in the following JSON format: {“type”: “BLE”, “payload”: {“ble_service_id”: uuid, “ble_characteristic_id”: uuid, “ble_characteristic_value”: value}, “time”: {“start_in_seconds”: 10, “duration_in_seconds”: 5}, “strength”: “55dB”}. In this example, the identifier 116 is defined as “payload”. The signal data 106 can also be represented in similar formats, such as XML, CSV, etc.

After the signal data 106 is extracted 126 by the decoder module 112, the extracted signal data 106, e.g. the identifier 116 and/or the other relevant data as exemplified above in the JSON format, can be transmitted 134 to a signal transceiver module 119. The signal transceiver module 119 will be described in detail in the present application.

As shown in FIG. 1, the system 100 includes a processor module 120. In one implementation, the processor module 120 is in wireless communication with the decoder module 112. The processor module 120, if it receives 134 the signal carrying the identifier 116 and/or the other relevant data, is configured to retrieve 128 the product data 118 from the memory module 110 in response to the identifier 116. For the sake of simplicity, the other relevant data is not shown. In an embodiment, the signal carrying the extracted signal data 106 that includes the identifier 116 and/or the other relevant data is received 134 by the signal transceiver module 119. The signal transceiver module 119 may be part of the processor module 120 such that the processor module 120 is configured to receive 134 the extracted signal data 106 that includes the identifier 116 and/or the other relevant data. Alternatively, the signal transceiver module 119 may be a stand-alone module working in co-operation with the processor module 120.

As described above, the identifier 116 that is associated with the product data 118 is pre-stored in the memory module 110. In response to an instruction for the processor module 120 to retrieve 128 the product data 118, the product data 118 is located based on the identifier 116 and the located product data 118 is communicated 130 to an output module 114. The output module 114 may include a display screen capable of displaying a user interface showing the product data. In an embodiment, the output module 114 may include the processor module 120. In such an embodiment, the processor module 120 may further include the signal transceiver module 119.

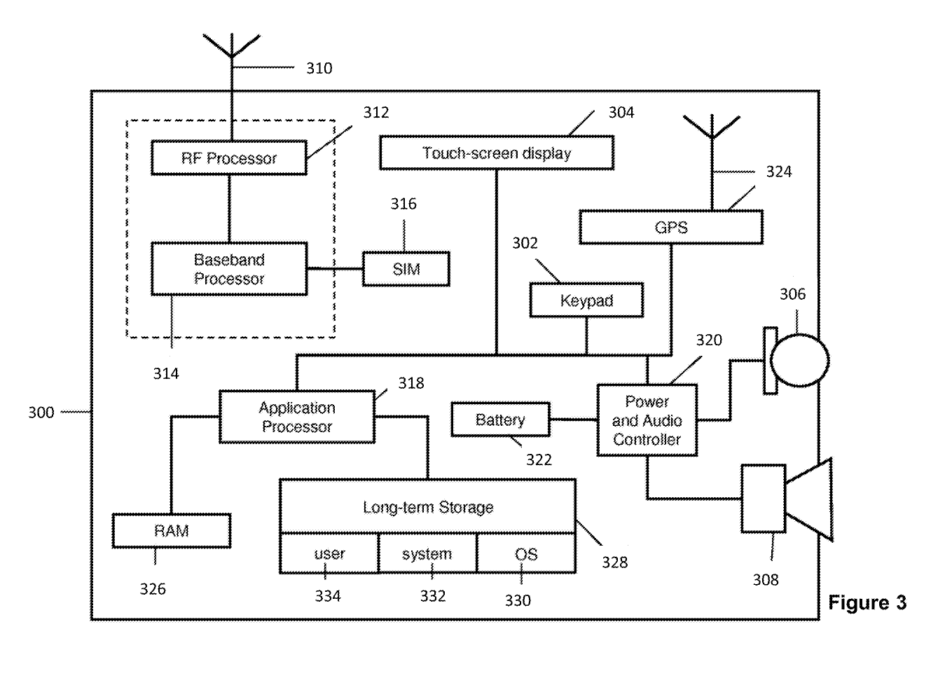

In an implementation, the system 100 may include a wireless electronic device (or any electronic device with data connectivity), such as a mobile phone or a mobile tablet computer. The wireless electronic device will be described in detail in the present application as shown in FIG. 3. The wireless electronic device may include the output module 114, the processor module 120 and/or the signal transceiver module 119. The wireless electronic device may further include a user input module (e.g. keypad, touchscreen, etc.) configured to allow the consumer to instruct the processor module 108 to retrieve the product data 118 from the memory module 110 while the visual representation 122 of at least part of the product 102 is being displayed on the receiver module 108. In such an implementation, the receiver module 108 is configured to receive 124 the data package 104 and display the visual representation 122 included in the data package 104. As described above, the receiver module 108 may be a digital photo frame that is configured to display pictures and videos, or a TV screen, or a display of a personal computer, or an outdoor display screen. For example, the receiver module 108 may be an outdoor display screen that displays advertisements. The advertisements may be an image or a video about the product 102. For example, if the product 102 is a dress, the outdoor display screen 108 receives 124 a data package 104 including a visual representation 122 in the form of an image of a model wearing the dress and signal data 106. The signal data 106 includes an identifier 116 of product data 118 associated with the dress and/or other relevant data as described above. Where the visual representation 122 is in the form of a video of a model wearing the dress, the other relevant data includes data representing time related information associated with the product data 118, e.g. the time to start communicating 130 the product data 118 and the duration of the communication 130 of the product data 118.

In an embodiment, the product data 118 associated with the dress may be a description of the dress (color, shape, material, model name, manufacturer, key features, etc.), price of the dress, and merchant(s) who is/are offering the dress for sale (name of merchant, address of merchant's store, address of merchant's web-store, etc.). The product data 118 is stored in the memory module 110 in association with the identifier 116. As the receiver module 108 starts displaying the visual representation, the signal data 106 is extracted 126 by the decoder module 112 from the data package 104, and a signal carrying the extracted signal data 106 that includes the identifier 116 and/or other relevant data is transmitted 134 to wireless electronic devices that have the signal transceiver module 119 configured for data exchange in accordance with communication protocols, such as Bluetooth, BLE, Wi-Fi®, Wi-Fi Direct®, and the like. In this implementation, the output module 114 (e.g. a display screen) of any of these wireless electronic devices is configured to output the product data 118 to the consumer corresponding to the product 102 that is being displayed on the outdoor screen 108. That is, the description of the dress (color, shape, material, model name, manufacturer, key features, etc.), price of the dress, and merchant(s) who is/are offering the dress for sale (name of merchant, address of merchant's store, address of merchant's web-store, etc.) can be displayed on the output module 114 of the wireless electronic device so that a consumer who is looking at the wireless electronic device is able to identify and know more about the product. In this embodiment, if the address of the merchant's web-store is communicated 130, the consumer who is interested may click the address and is directed 138 to the merchant's web-store 136 for further browsing and/or purchasing. Such a system of communicating the product data 118 corresponding to the product 102 that is being displayed on the receiver module 108 advantageously reduces the hassle of looking for information about that product 102 and can generate more visiting opportunities for the merchant's store, either online or offline.

In another implementation, the decoder module 112 and the output module 114 may be incorporated into the receiver module 108 as a stand-alone component. The output module 114 may include the processor module 120. The receiver module 108 may include an outdoor display screen. For example, where the product 102 is French fries, the outdoor display screen 108 receives 124 a data package 104 including a visual representation 122 in the form of an image of the French fries and signal data 106. The signal data 106 includes an identifier 116 of product data 118 associated with the French fries and/or other relevant data as described above. In an embodiment, the product data 118 associated with the French fries may be a smell of the French fries. Data related to the smell of the French fries may be stored in the memory module 110 in association with the identifier 116.

In an embodiment, the output module 114 may include a sub-module (not shown) embodying digital scent technology configured to release one or more smells. The sub-module may contain cartridges with “primary smells”, which can be mixed to replicate natural and man-made smells. As the image of the French fries is being displayed, the decoder module 112 extracts 126 the signal data 106 and retrieves 128 the product data 118, i.e. data related to the smell of the French fries, from the memory module 110 using the processor module 120. The output module 114 receiving 130 the data related to the smell releases a simulated smell of the French fries using the sub-module that is configured to release one or more scents. The release of smells associated with the product may enhance a viewer's experience. One example of a suitable digital scent module includes a plurality of individually actuatable scent carriers and is described in PCT publication WO2014/144690.

As shown in FIG. 1, the system 100 may further include an encoder module 132 configured to create 140 the data package 104 including the visual representation 122 of at least part of the product 102 and the signal data 106.

In an embodiment, the encoder module 132 may be a recorder that is configured to detect and capture 142 the signal data 106 when recording 133 the visual representation 122 of at least part of the product 102. The signal data 106 may be transmitted from an emitter attached to the product 102. In this embodiment, the recorder 132 may be an electronic device having a camera or video recorder and is also configured to detect the signal. As described above, the signal may be in accordance with the communication protocols of Bluetooth™, Bluetooth™low energy (BLE), Wi-Fi®, Wi-Fi Direct®, and the like. Therefore, the recorder 132 may include a signal detector module, for example, a BLE detector module (not shown). In this manner, the encoder module 132 may be a digital camera or a mobile device (such as a mobile phone or a mobile tablet) that has a BLE detector module.

When the encoder module 132 is recording 133 the visual representation 122 of at least part of product 102 (e.g. taking a photo or recording a video of the product 102), the signal detector module in the encoder module 132 also detects and captures 142 the signal data 106 emitted during the recording 133 of the visual representation 122. As the visual representation 122 is being recorded 133, the encoder module 132 may encode the signal data 106 in the form of metadata of the visual representation 106, such that the data package 104 is created 140. The metadata may be encoded in an Exchangeable Image File (EIF) format, e.g. using tags such as “remote_signals” with the values described above exemplified in JSON format. Alternatively, the metadata may be encoded in an Extensible Metadata Platform (XMP) standard. In the data package 104, the metadata can be embedded within the visual representation 122, or can be stored as a standalone file accompanying the visual representation 122.

In another embodiment, the encoder module 132 is a stand-alone module which is configured to receive 133 the visual representation 122 of at least part of the product 102. The visual representation 122 is pre-recorded by a recorder/camera/mobile phone/mobile tablet. The recorder/camera/mobile phone/mobile tablet may not have any signal detector module to detect and/or capture signal data.

In the present embodiment, the visual representation 122 and signal data 106 are received 133 by the encoder module 132 and combined during a post-production/post processing step to create 140 the data package 104. As described above, the signal data 106 includes the identifier 116 that is stored in the memory module 110 in association with the product data 118. The signal data 106 may be transmitted from an emitter attached to the product 102. Upon receipt of both the visual representation 122 and the signal data 106, the encoder module 132 encodes the signal data 106 as metadata of the visual representation 122 in the same manner as the above describes. In this manner, the data package 104 is created 140.

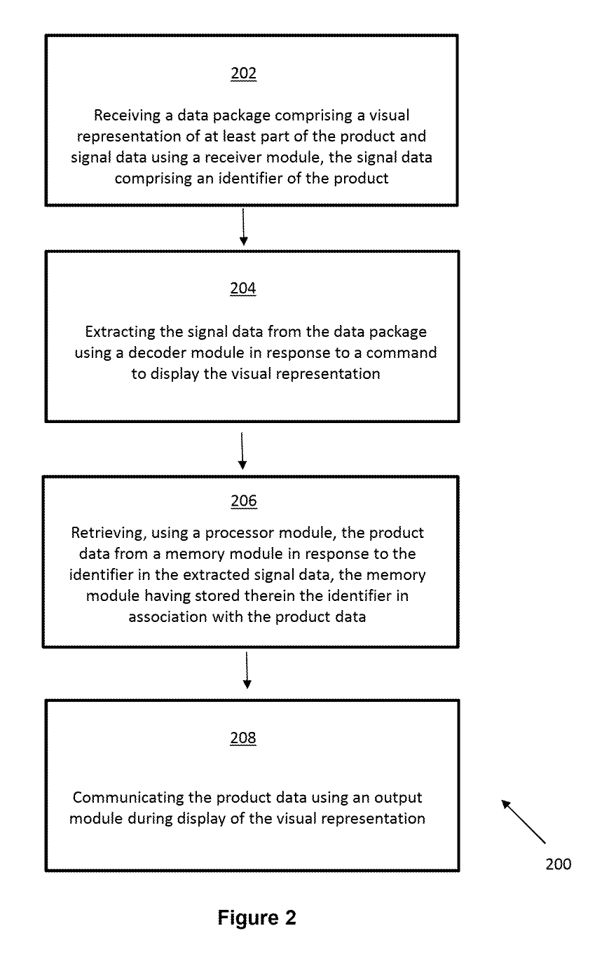

FIG. 2 shows a flow chart of a method 200 for communicating product data corresponding to a product according to an example embodiment. The method 200 includes the step 202 of using a receiver module 108 to receive a data package 104 including visual representation 122 of at least part of the product and signal data 106. The signal data 106 includes an identifier 116 of the product 102. The product data 118 includes, but is not limited to, a smell associated with the product 102, a sound associated with the product 102, a description associated with the product 102 (color, shape, material, model name, manufacturer, key features, etc.), a price associated with the product 102, and merchant(s) who is/are offering the product 102 for sale (name of merchant, address of merchant's store, address of merchant's web-store, etc.).

In an implementation, the data package 104 includes the visual representation 122 of at least part of the product 102 and the signal data 106 is created by an encoder module 132. The step of creating the data package may include embedding the signal data in the visual representation as metadata. The metadata is in accordance with one or more of Exchangeable Image File (EXIF) format or Extensible Metadata Platform (XMP) format.

The method 200 also includes the step 204 of using a decoder module 112 to extract the signal data 106 from the data package 104 in response to a command to display the visual representation 122.

The method 200 further includes the step 206 of retrieving, using a processor module 120, the product data 118 from a memory module 110 in response to the identifier 116 in the extracted signal data 106. The memory module 110 has the identifier 116 stored therein in association with the product data 118.

Furthermore, the method 200 includes the step 208 of using an output module 114 to communicate the product data 118 during display of the visual representation 122. In an implementation, the visual representation 122 is displayed on the receiver module 108.

The method 200 may further include receiving the extracted signal data using a signal transceiver module.

FIG. 3 shows a schematic of an exemplary wireless computing device 300 that may be utilized to implement the wireless electronic device of the system 100.

The wireless device 300 includes a keypad 302 (which may function as the user input module described above), a touch-screen 304 (which may function as the user input module and/or the output module 114 described above), a microphone 306, a speaker 308, and an antenna 310. The wireless device 300 is capable of being operated by a user to perform a variety of different functions, such as, for example, hosting a telephone call, sending an SMS message, browsing the Internet, sending an email, and providing satellite navigation.

The wireless device 300 includes hardware to perform communication functions (e.g. telephony, data communication), together with an application processor and corresponding support hardware to enable the wireless device 300 to have other functions, such as messaging, Internet browsing, email functions, and the like. The communication hardware is represented by a radio frequency (RF) processor 312 which provides an RF signal to the antenna 310 for the transmission of data signals, and the receipt therefrom. Additionally, a baseband processor 314 is provided. The baseband processor 314 provides signals to and receives signals from the RF Processor 312. The baseband processor 314 also interacts with a subscriber identity module (SIM) 316, as is well known in the art. The communication subsystem enables the wireless device 300 to communicate via a number of different communication protocols including 3G, 4G, GSM, WiFi, WiFi Direct, RFID, Bluetooth™, Bluetooth™ low energy (BLE), and/or CDMA. The communication subsystem of the wireless device 300 is beyond the scope of the present disclosure. However, the communication subsystem preferably allows communication with decoder module and memory module used in embodiments of the disclosure as described above.

The keypad 302 and the touch-screen 304 are controlled by an application processor 318. A power and audio controller 320 is provided to supply power from a battery 322 to the communication subsystem, the application processor 318, and the other hardware. The power and audio controller 320 also controls input from the microphone 306, and audio output via the speaker 308. A global positioning system (GPS) antenna and associated receiver element 324 which is controlled by the application processor 318 and is capable of receiving a GPS signal for use with a satellite navigation functionality of the wireless device 300 are provided.

In order for the application processor 318 to operate, various different types of memory are provided. Firstly, the wireless device 300 includes Random Access Memory (RAM) 326 connected to the application processor 318 into which data and program code can be written and read from at will. Code placed anywhere in RAM 326 can be executed by the application processor 318 from the RAM 326. RAM 326 represents a volatile memory of the wireless device 300.

Secondly, the wireless device 300 is provided with a long-term storage 328 connected to the application processor 318. The long-term storage 328 includes three partitions, an operating system (OS) partition 330, a system partition 332, and a user partition 334. The long-term storage 328 represents a non-volatile memory of the wireless device 300.

In the present example, the OS partition 330 contains the firmware of the wireless device 300 which includes an operating system. Other computer programs may also be stored on the long-term storage 328, such as application programs (also referred to as apps), and the like. In particular, application programs which are mandatory to the wireless device 300, such as, in the case of a smartphone, communications applications, and the like are typically stored in the system partition 332. The application programs stored on the system partition 332 could typically be those which are bundled with the wireless device 300 by the device manufacturer when the wireless device 300 is first sold.

Application programs which are added to the wireless device 300 by the user could usually be stored in the user partition 334.

As stated, the representation of FIG. 3 is schematic. In practice, the various functional components illustrated may be substituted into one and the same component. For example, the long-term storage 328 may include NAND flash, NOR flash, a hard disk drive or a combination of these.

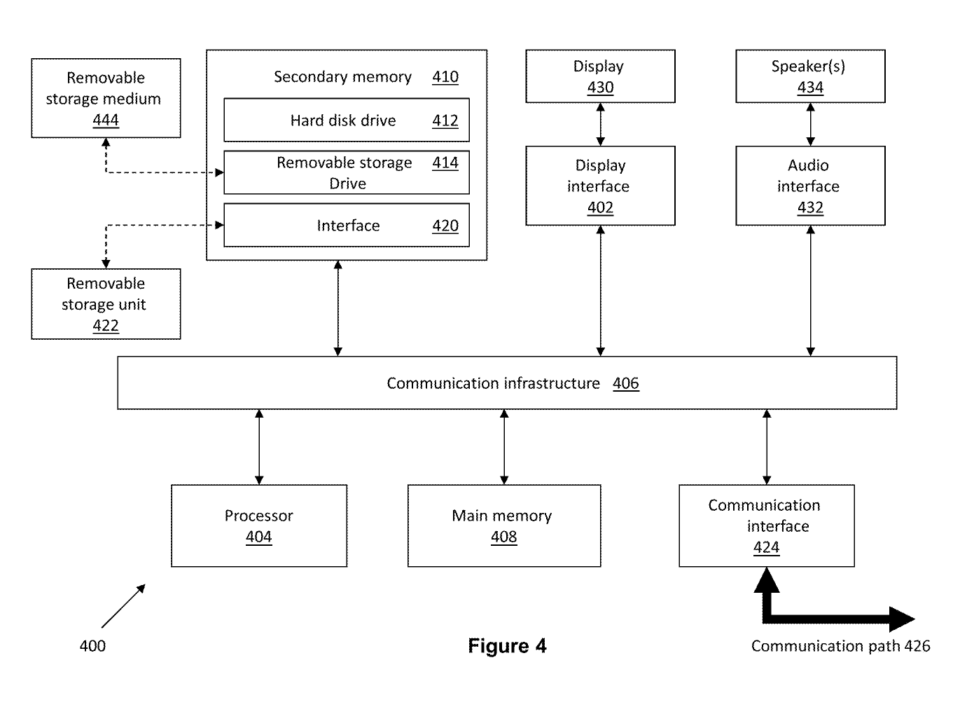

FIG. 4 depicts an exemplary computing device 400, hereinafter interchangeably referred to as a computer system 400, where one or more such computing devices 400 may be used to realize at least a part of the receiver module 108, the decoder module 112, the processor module 120, the output module 114, the encoder module 132, and/or other (sub)modules described herein. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a hard disk drive 412 and/or a removable storage drive 414, which may include a magnetic tape drive, an optical disk drive, or the like. The secondary memory 410 may be used to store product data and corresponding signals (transmittable product identities). The removable storage drive 414 reads from and/or writes to a removable storage unit 418 in a well-known manner. The removable storage unit 418 may include a magnetic tape, optical disk, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the disclosure, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port, an antenna with associated circuitry, and the like. The communication interface 424 may be wired or may be wireless. Software and data transferred via the communication interface 424 are in the form of signals which can be electronic, electromagnetic, optical, or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, USB memory, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

1. A method for communicating product data corresponding to a product, the method comprising:
receiving a data package comprising a visual representation of at least part of the product and signal data using a receiver module, the signal data comprising an identifier of the product;
extracting the signal data from the data package using a decoder module in response to a command to display the visual representation;
retrieving, using a processor module, the product data from a memory module in response to the identifier in the extracted signal data, the memory module having stored therein the identifier in association with the product data; and
communicating the product data using an output module during display of the visual representation.

2. The method as claimed in claim 1, further comprising creating the data package comprising the visual representation of at least part of the product and the signal data using an encoder module.

3. The method as claimed in claim 2, wherein creating the data package comprises embedding the signal data in the visual representation as metadata, wherein the metadata is in accordance with one or more of Exchangeable Image File (EXIF) format or Extensible Metadata Platform (XMP) format.

4. The method as claimed in claim 1, further comprising receiving the extracted signal data using a signal transceiver module.

5. The method as claimed in claim 1 wherein the visual representation comprises one or more of an image file or a video file.

6. The method as claimed in claim 5, wherein when the visual representation comprises a video file, the signal data further comprises data representing time related information.

7. The method as claimed in claim 1 wherein the product data comprises one or more of: a smell associated with the product, a sound associated with the product, a description associated with the product, a price of the product, and a merchant who is offering the product.

8. The method as claimed in claim 1, wherein the signal data comprises data representing a signal transmittable in accordance with one or more of: Bluetooth™, Bluetooth™ low energy (BLE), Wi-Fi®, and Wi-Fi Direct® communication protocols.

9. The method as claimed in claim 1, wherein the signal data is in accordance with one or more of: JavaScript Object Notation (JSON) format, Extensible Markup Language (XML) format, and tabular format.

10. The method as claimed in claim 1, wherein the signal data further comprises data representing a strength of the signal.

11. A system for communicating product data corresponding to a product, the system comprising:
a receiver module configured to receive a data package comprising a visual representation of at least part of the product and signal data, the signal data comprising an identifier of the product;
a decoder module configured to extract the signal data from the data package in response to a command to display the visual representation;
a processor module configured to retrieve the product data from a memory module in response to the identifier in the extracted signal data, the memory module having stored therein the identifier in association with the product data; and
an output module configured to communicate the product data during display of the visual representation.

12. The system as claimed in claim 11, further comprising an encoder module configured to create the data package comprising the visual representation of at least part of the product and the signal data.

13. The system as claimed in claim 12, wherein the encoder module is configured to embed the signal data in the visual representation as metadata, wherein the metadata is in accordance with one or more of Exchangeable Image File (EXIF) format or Extensible Metadata Platform (XMP) format.

14. The system as claimed in claim 11, further comprising a signal transceiver module configured to receive the extracted signal data.

15. The system as claimed in claim 14, wherein the processor module comprises the signal transceiver module, and wherein the processor module is embedded with the output module.

16. The system as claimed in claims 11, wherein the visual representation comprises one or more of an image file or a video file.

17. The system as claimed in claim 16, when the visual representation comprises a video file, the signal data further comprises data representing time related information.

18. The system as claimed in claim 11, wherein the product data comprises one or more of: a smell associated with the product, a sound associated with the product, a description associated with the product, a price of the product, and a merchant who is offering the product.

19. The system as claimed in claim 11, wherein the signal data comprises data representing a signal transmittable in accordance with one or more of: Bluetooth™, Bluetooth™ low energy (BLE), Wi-Fi®, and Wi-Fi Direct® communication protocols.

20. The system as claimed in claim 11, wherein the signal data is in accordance with one or more of: JavaScript Object Notation (JSON) format, Extensible Markup Language (XML) format, and tabular format.

21. The system as claimed in claim 11, wherein the signal data further comprises data representing a strength of the signal.
